(19) United States
(12) Patent Application Publication
(10) Pub. No.: US 2011/0146179 A1
(43) Pub. Date: Jun. 23, 2011

(54) MOLDED PANEL SIMULATING MULTIPLE BOARDS

(76) Inventors: Richard W. Cantley, Birmingham, MI (US); Nick M. Kokotovich, Gaylord, MI (US)

(21) Appl. No.: 12/640,569

(22) Filed: Dec. 17, 2009

(51) Int. Cl. B44F 7/00

(52) U.S. Cl. 52/313

(57) ABSTRACT

A unitary molded panel simulates the appearance of a plurality of boards. A body of molded material has a plurality of elongated board elements each with a top face, a pair of opposed end faces, and a pair of opposed side edges. The end faces define a thickness of the board elements. The board elements are parallel to one another and spaced apart so as to define a width of the body. Connection elements each extend between and interconnect the side edges of adjacent board elements. The connection elements provide the only connection between adjacent board elements. Each connection element has a pair of opposed ends and an upper surface extending between the ends. The entirety of the upper surface of each connection element is spaced below the upper plane. Each of the ends is spaced inwardly from the end faces of the adjacent board elements.

### FIELD OF THE INVENTION

The present invention relates generally to molded panels and, more specifically, to a molded panel that simulates the appearance of a plurality of boards and that is usable as decking such as on docks.

### BACKGROUND OF THE INVENTION

Traditionally, structures such as docks and boardwalks have been constructed by building a support structure and then covering the support structure with a plurality of individual decking boards. The support structure may be constructed from a variety of materials and designed for a specific installation, or may be a modular structure that is assembled out of multiple modular elements. While traditionally wooden boards have been used as decking on these structures, more recently there has been a move towards metal decking and synthetic decking, such as synthetic lumber. However, despite the move to more modern building materials, these structures are still typically constructed by positioning multiple independent deck “boards” on top of the support structure and individually fastening these boards to the structure. Even with the use of synthetic lumber, the raw lumber must be cut to length and individually fastened to the underlying structure. This consumes a lot of time and also often necessitates skilled labor. Additionally, the finished structure typically has the ends of the cut off boards defining an edge of the structure. Because the boards have been cut, these edges typically meet the upper surface at a 90 degree corner. This corner can be unpleasantly sharp or rough especially in applications such as docks where swimmers may be entering and exiting the water over the edge of the dock. While these edges may be radiused, this is an additional time-consuming step.

While there are decking panels known in the art, these panels do not satisfactorily mimic the look of individual boards. Instead, they have the look of an industrial panel. In light of this, there remains a need for improved decking panels, especially that simulate the look of individual boards.

### SUMMARY OF THE INVENTION

The present invention provides a unitary molded panel that simulates the appearance of a plurality of individual boards, and which may be used in applications such as decking for docks. The unitary molded panel is a body of molded material having an upper face disposed generally in an upper plane and a lower face generally disposed in a lower plane. These planes are parallel. The body of molded material includes a plurality of elongated board elements each having a top face generally disposed in the upper plane such that the top faces cooperate to define the upper face of the body of molded material. Each board element has a pair of opposed side edges and a pair of opposed end faces. The side edges extend longitudinally between the end faces. Each of the side edges and each of the end faces extends generally perpendicularly to the upper plane. The end faces extend generally from the upper plane to the lower plane so as to define a thickness of the board elements. The plurality of elongated board elements are parallel to each other and are spaced apart so as to define a width of the body of molded material. A plurality of connection elements each extends between and interconnects the side edges of a pair of adjacent board elements. The connection elements provide the only connection between adjacent board elements. Each connection element has a pair of opposed ends and an upper surface extending between the ends. The entirety of the upper surface of each connection element is spaced below the upper plane, and no portion of each connection element extends above the upper surface. Each of the ends of the connection elements is spaced inwardly from the end faces of the adjacent board elements. No portion of the body of molded material extends above the upper plane or below the lower plane.

### BRIEF DESCRIPTION OF THE DRAWINGS

FIG. 1 is a perspective view of a molded panel according to an embodiment of the present invention;

FIG. 2 is a top view of the panel of FIG. 1;

FIG. 3 is a bottom view of the panel of FIGS. 1 and 2;

FIG. 4 is an end view of the panel of FIGS. 1-3 showing exemplary dimensions therefor; and

FIG. 5 is a side view of the panel of FIGS. 1-4 with a portion cut away to show water drainage.

### DETAILED DESCRIPTION OF THE PREFERRED EMBODIMENTS

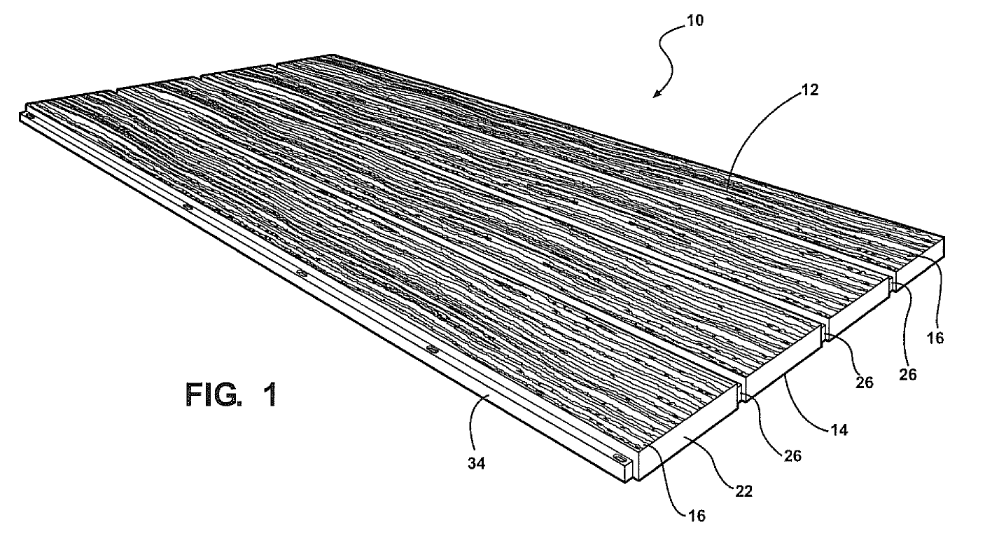

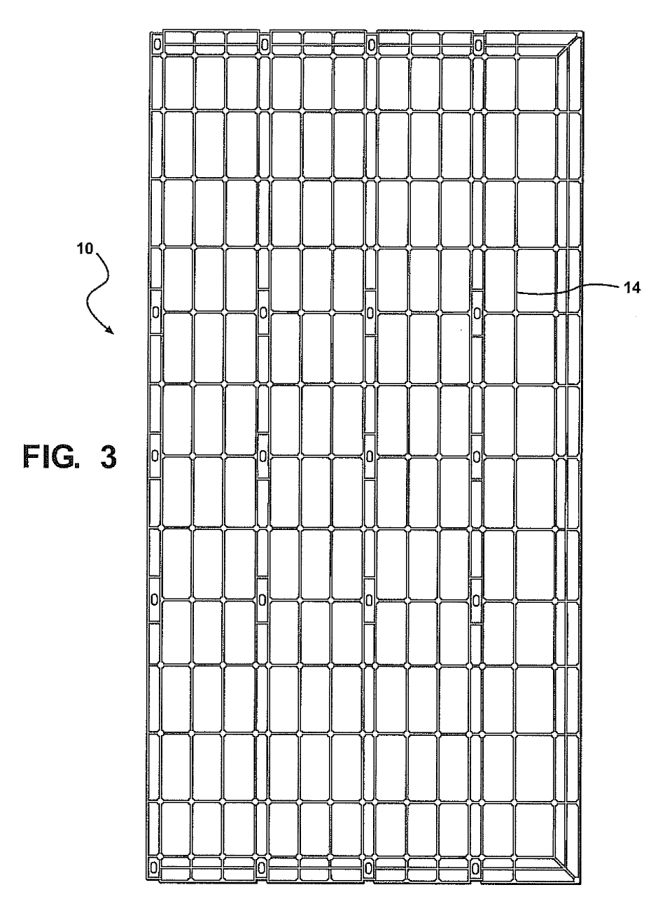

Referring to FIGS. 1-3, a molded panel is generally shown at 10. The panel 10 is preferably molded, such as injection molded, as a unitary piece out of unreinforced or reinforced polymer. The panel 10 is designed to simulate the look of multiple boards and may be used in a variety of applications such as decking for docks. In the illustrated embodiment, the panel 10 simulates the look of four “boards” separated by spacers or connection elements that interconnect the “boards” to form a unitary panel. A plurality of openings may be provided in the connection elements for use in connecting the panel to an underlying structure and/or allowing drainage of water from the upper surface of the panel. As shown in FIG. 3, the panel has an open lower surface and includes a grid of reinforcement ribs to provide structural strength to the panel.

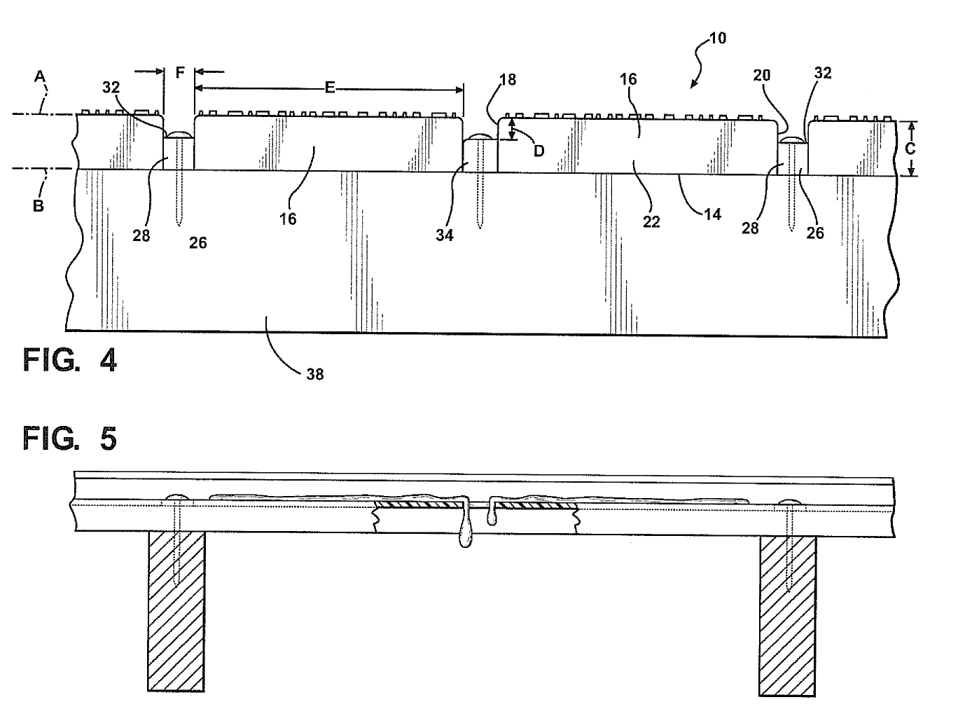

Referring now to FIGS. 1, 2 and 4, the panel 10 will be described in more detail. The panel 10 is a body of molded material that has an upper face 12 disposed generally in an upper plane A and a lower face 14 generally disposed in a lower plane B. The planes A and B are parallel to one another. The panel includes a plurality of elongated board elements 16 that each have the appearance of an individual board, such as a real wooden board. Each board element has a pair of opposed side edges 18 and 20 and a pair of opposed end faces 22 and 24. The side edges extend longitudinally between the end faces. As best shown in FIG. 4, the side edges extend generally perpendicularly to the upper plane A. Likewise, the end faces extend generally perpendicularly to the upper plane. As used herein, “generally perpendicular” means that the angle appears to be perpendicular, and this terminology is intended to cover variations from fully perpendicular, such as may occur to provide draft angles in the mold. Each of the end faces 22 and 24 extend generally from the upper plane A to the lower plane B so as to define a thickness C of the board elements. As best shown in FIG. 1, the fact that the end faces extend for the full thickness of the panel helps to achieve the appearance of individual boards. Where two generally perpendicular faces or edges meet, the intersection is preferably radiused.

As shown, the plurality of elongated board elements are parallel to one another and spaced apart so as to define a width of the body of molded material. In the illustrated embodiment, the board elements each have a width E, defined as the distance between the side edges 18 and 20, and a thickness, defined as the distance between the upper surface 12 and lower surface 14, generally equal to the dimensions of a traditional 5/4 by 6 piece of lumber. The width is approximately 5⅜ to 5.5 inches and the thickness C is approximately 1 inch. The board elements 16 are spaced apart from one another by a distance F. In the illustrated embodiment, this distance is approximately 0.5 inches.

A plurality of connection elements 26 each extend between and interconnect the side edges of a pair of adjacent board elements 16. These connection elements 26 provide the only connection between adjacent board elements. Each of the connection elements has a pair of opposed ends 28 and 30 and an upper surface 32 that extends between the ends 28 and 30. As shown, the entirety of the upper surface 32 of each connection element 26 is spaced below the upper plane A, and no portion of each connection element 26 extends above this upper surface 32. As best shown in FIG. 1, the fact that these connection elements are entirely spaced below the upper surface of the panel 10 helps to achieve the look that the board elements 16 are individual discrete boards, rather than being part of a unitary panel. In the illustrated embodiment, the upper surface 32 of the connection elements is spaced below the plane A by a distance D of ⅜ths of a inch, though other spacings may be used.

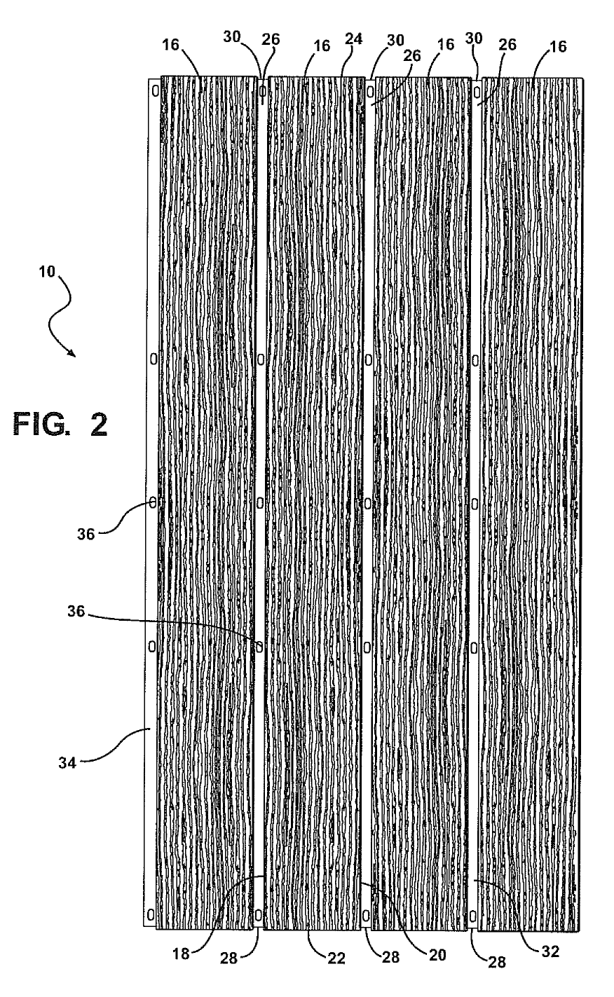

As best shown in FIGS. 1 and 2, the ends 28 and 30 of the connection elements are spaced inwardly from the end faces 22 and 24, respectively, of the adjacent board elements. This again assists in providing the impression that the board elements 16 are discrete boards, since the end faces 22 and 24 have the same dimensions as traditional lumber. In this case, the end faces have the appearance of traditional 5/4 by 6 lumber. Alternative embodiments may have different thicknesses and widths than illustrated, such as for example having the thickness and width of traditional 2 by 6 lumber, which has a thickness of 1½ inches and a width of 5½ inches.

Preferred embodiments of the present invention are designed to be installed side by side with a plurality of other identical panels to provide a continuous decking surface, such as on a dock. For this purpose, an additional connection element 34 is connected with the outer side of one of the board elements 16 such that it defines one side of the overall panel. As shown in FIG. 4, this additional connection element 34 buts up against the side of an adjacent panel so as to provide identical spacing between the “boards” at the sides of the panels and the “boards” within a panel. As such, the additional connection element 34 has a width of approximately 0.5 inches for the illustrated embodiment. Therefore, the illustrated embodiment has an overall width of approximately 2 feet. The illustrated embodiment has an end-to-end length of approximately 4 feet. As will be clear to those of skill in the art, other dimensions may be used.

Referring again to FIG. 2, it can be seen that the end faces 22 of the board element 16 each lie in the same plane, and the end faces 24 also lie in the same plane. In an alternative embodiment, the end faces may not all lie in the same plane, thereby giving the appearance of a more rustic looking dock. As shown in FIG. 2, each of the connection elements 26 and 34 include a plurality of openings 36 defined therethrough. As shown in FIG. 4, these openings may receive fasteners, such as nails or screws, for attaching the panel to an underlying structure 38. Some or all of these openings may also serve as drainage holes, as shown in FIG. 5.

As shown in various figures, the upper surface of the panel 10 preferably has a texture disposed thereon to simulate wood grain. Other patterns may also be used. In preferred embodiments, the texture is formed in accordance with applicant's co-pending application entitled “Article with Inverse Grain Pattern”, Ser. No. 12/640,436, filed Dec. 17, 2009, the entire contents of which are incorporated herein by reference.

The panels 10 are preferably formed by injection molding or other molding technology and formed out of a reinforced or non-reinforced polymer or polymer blend. An exemplary material is referred to as a “no break” copolymer polypropylene, though other materials may be used. The panels could also be formed of materials such as various metals.

As will be clear to those of skill in the art, panels in accordance with the present invention allow the construction of structures such as docks much more quickly than may be done with traditional lumber or synthetic lumber. Additionally, the panels provide the appearance of individual boards, unlike other types of panels. As also clear to those of skill in the art, the herein described embodiments of the present invention may be altered in various ways without departing from the scope or teaching of the present invention. It is the following claims, including all equivalents, which define the scope of the present invention.

1) A unitary molded panel simulating the appearance of a plurality of boards, the panel comprising:
a body of molded material having an upper face generally disposed in an upper plane and a lower face generally disposed in a lower plane, the planes being parallel, the body of molded material including;
a plurality of elongated board elements each having a top face generally disposed in the upper plane such that the top faces cooperate to define the upper face of the body of molded material;
each board element having a pair of opposed side edges and a pair of opposed end faces, the side edges extending longitudinally between the end faces;
each of the side edges and each of the end faces extending generally perpendicularly to the upper plane; and
the end faces extending generally from the upper plane to the lower plane so as to define a thickness of the board elements;
the plurality of elongated board elements being parallel to each other and spaced apart so as to define a width of the body of molded material; and
a plurality of connection elements each extending between and interconnecting the side edges of a pair of adjacent board elements, the connection elements providing the only connection between adjacent board elements;
each connection element having a pair of opposed ends and an upper surface extending between the ends;
the entirety of the upper surface of each connection element being spaced below the upper plane, no portion of each connection element extending above the upper surface; and
each of the ends being spaced inwardly from the end faces of the adjacent board elements;
wherein no portion of the body of molded material extends above the upper plane or below the lower plane.

2. A unitary molded panel in accordance with claim 1, wherein the end faces at a first end of the body of molded material are generally coplanar and the end faces at an opposed end of the body of molded material are generally coplanar.

3. A unitary molded panel in accordance with claim 1, wherein the upper surfaces of the connection elements are generally coplanar.

4. A unitary molded panel in accordance with claim 3, wherein upper surfaces of the connection elements are generally parallel to the upper plane.

5. A unitary molded panel in accordance with claim 1, wherein the connection elements have a plurality of connector holes defined therein.

6. A unitary molded panel in accordance with claim 1, wherein the lower face of the body of molded material is open and a grid of reinforcing ribs is defined on a bottom surface of the board elements and connection elements.

7. A unitary molded panel in accordance with claim 1, wherein at least the top faces of the elongated board elements have a grain texture defined thereon.

8. A unitary molded panel in accordance with claim 1, further comprising an extra connection element extending from a side edge of an elongated board element at a side of the body of molded material, the extra connection element abutting an adjacent molded panel when a plurality of molded panels are disposed side by side.
